(19) United States
(12) Patent Application Publication
(10) Pub. No.: US 2007/0077180 A1
(43) Pub. Date: Apr. 5, 2007

(54) DEVICE FOR PREPARATION OF OIL RECIPES FOR AROMATHERAPY

(75) Inventors: Bernd Griasch, Neuhofen (DE); Peter Schorn-Bars, Hoechst (DE); Tom Macke, Bonn (DE); Jan Macke, Bonn (DE)

Correspondence Address: HOGAN & HARTSON LLP, ONE TABOR CENTER, SUITE 1500, 1200 SEVENTEENTH ST, DENVER, CO, 80202, US

(73) Assignees: BERND GRIASCH, Neuhofen (DE); C. GERHARDT FABRIK UND LAGER CHEMISCHER APPARATE GMBH & CO. KG, ET AL., Koenigswinter (DE)

(21) Appl. No.: 11/531,938

(22) Filed: Sep. 14, 2006

(30) Foreign Application Priority Data
Sep. 16, 2005 (DE) 202005014704.4

(51) Int. Cl. B01L 3/02

(52) U.S. Cl. 422/100

(57) ABSTRACT

A device for preparing oil recipes for aromatherapy includes an essential oil container arrangement having a number of essential oil containers, a base oil container arrangement which includes at least one base oil container having a volume larger than the volume of an essential oil container, a product container arrangement which includes at least one product container, a pipetting device which includes a pipetting needle for removing a predetermined volume of liquid, a drive unit which moves the pipetting device in a plane extending parallel to the plane covered by the essential oil container arrangement so that the pipetting needle is brought in a direction perpendicular to a selected container, and a central control unit with an assigned data input device for controlling the pipetting device and the drive unit such that a predetermined blend of essential and base oils can be made available in the product container.

### RELATED APPLICATION

The present application claims priority of German Patent Application No. 202005014704.4 filed Sep. 16, 2005, which is incorporated herein in its entirety by this reference.

### FIELD OF THE INVENTION

The invention relates to devices for preparation of oil recipes for aromatherapy.

### BACKGROUND OF THE INVENTION

With aromatherapy the specific use of active substances is involved which are contained in essential oils with vegetable ingredients. Although each single essential oil contains a multitude of vegetable ingredients, it has been found that a large number of symptoms can be treated in the best possible manner by a combined effect of various vegetable oils. Sometimes the person to be treated suffers from a number of symptoms which should be countered by the best possible mixture of various vegetable oils.

The vegetable oils for aromatherapy are nowadays sold in pure form in small bottles. The end customer has to purchase various small bottles for a combined therapeutic use of different essential oils. Here, there is the problem that due to the mixing ratios and, optionally after a temporarily restricted therapy, substantial residues of essential oils remain.

Alternatively, the customer can have an essential oil combination mixed at a pharmacist's premises, which however leads to substantially more related effort and therefore costs due to the working time and documentation of the mixture used.

### SUMMARY OF THE INVENTION

The object of the invention is to provide an effective and easily used way of preparing oil recipes for aromatherapy.

To solve this problem, with this invention a device is provided for the preparation of oil recipes for aromatherapy, which comprises an essential oil container arrangement, a base oil container arrangement, a product container arrangement as well as a motor-driven pipetting device and a central control unit which controls the travel of the pipetting device and also the pipetting activity of the pipetting device. The essential oil container arrangement comprises a large number of essential oil containers, each of which contains a different essential oil. The base oil container arrangement comprises at least one base oil container. This base oil is an oil which essentially has no therapeutic effect and is only used as an oil-based diluting agent for the one or more essential oils. The base oil container has a volume which is substantially larger than the volume of the active container. By this is meant a volume ratio between the volume of the base oil container and the volume of the essential oil container of at least 20:1.

The pipetting device has a drive unit which is controlled from the central control unit and which moves the pipetting device in a plane which extends essentially parallel to the plane in which the essential oil container arrangement is located. The pipetting needle of the pipetting device can move perpendicular to this movement direction and can therefore be brought into the respective essential oil container.

In the central control unit blend ratios between one or more essential oils and one or more base oils are saved in dependence of one or more indications. Alternatively, the blend ratio can also be calculated or entered based on calculation rules and empirical values from aromatherapy. Through the results of blended compositions, the control unit controls the pipetting device to remove a predetermined volume from the base oil container or containers and from the essential oil container or containers and to deliver it into a product container. The device according to the invention comprises in this respect a product container arrangement which comprises at least one product container.

Preferred embodiments of the device according to the invention are given in the dependent claims.

### BRIEF DESCRIPTION OF THE DRAWINGS

The invention is explained in more detail with reference to an embodiment in conjunction with the following drawings:

FIG. 1 shows a perspective view of a housing of an embodiment of the present invention;

FIG. 2 shows constituent parts of the embodiment shown in FIG. 1, accommodated in the housing;

FIG. 3 shows a container arrangement of the embodiment of FIG. 1;

FIGS. 4a, 4b and 4c show a sequence of masks for determining a blend ratio during the operation of an embodiment of the present invention;

FIG. 5 shows a perspective front elevation of an alternative embodiment of the present invention, with open housing; and

FIG. 6 shows a back view in a closed state of the embodiment of FIG. 5.

### DETAILED DESCRIPTION

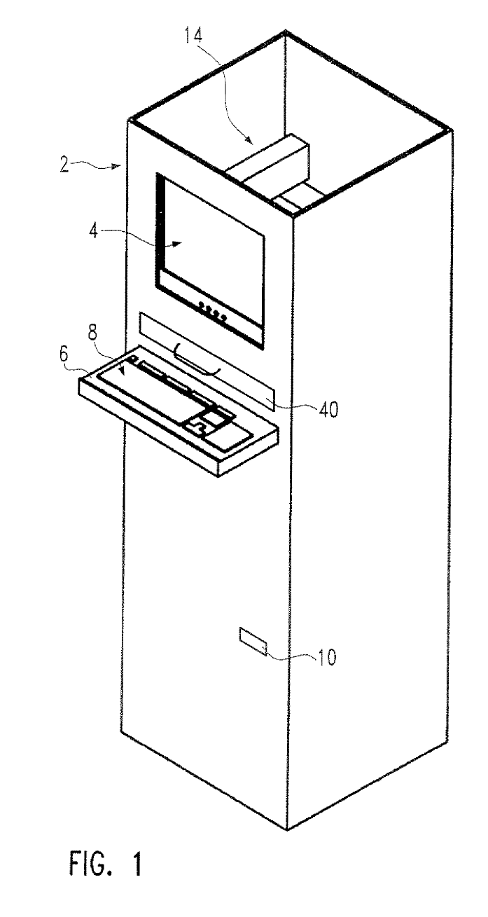

FIG. 1 shows a perspective view of a housing 2 of an embodiment of a device for the preparation of oil recipes which is formed similar to a tower and has a number of functional levels arranged one above the other which are explained in more detail in the following. On a face side a monitor 4 and an annunciator 6 holding a keyboard 8 are arranged. A label output slot 10 is located below the annunciator 6.

In the viewing direction behind the monitor 4 a pipetting device 12 is provided according to a type of autosampler known in laboratory technology. The pipetting device 12 is controlled from a central control unit 14 which controls a label printer 16 and displays its signals on the monitor 4.

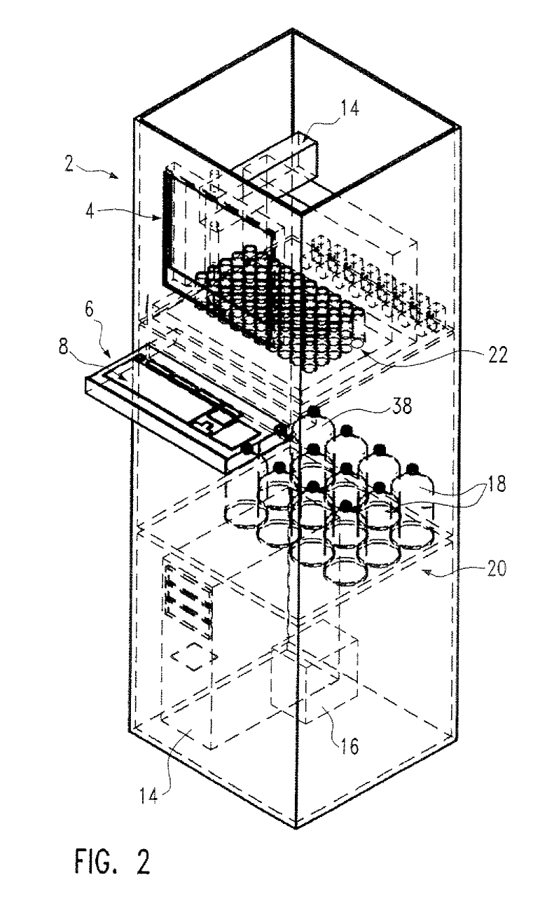

The control unit 14 and the label printer 16 are located on a lower level of the housing 2 (cf. FIG. 2). A number of base oil containers 18 are held in a base oil container arrangement 20 on a level above that. The base oil container arrangement 20 is contained by a trough which is not illustrated and which acts as an overflow container and which contains a grid by which the individual base oil containers 18 are kept at a predetermined place within the base oil container arrangement 20.

On the plane situated above this there is an essential oil container arrangement 22 with a large number of essential oil containers 24. The essential oil containers 24 are accommodated in groups of 12 in a separate essential oil container holder 26. All the essential oil container holders 26 are mounted on a slide which can be moved relative to the housing 2.

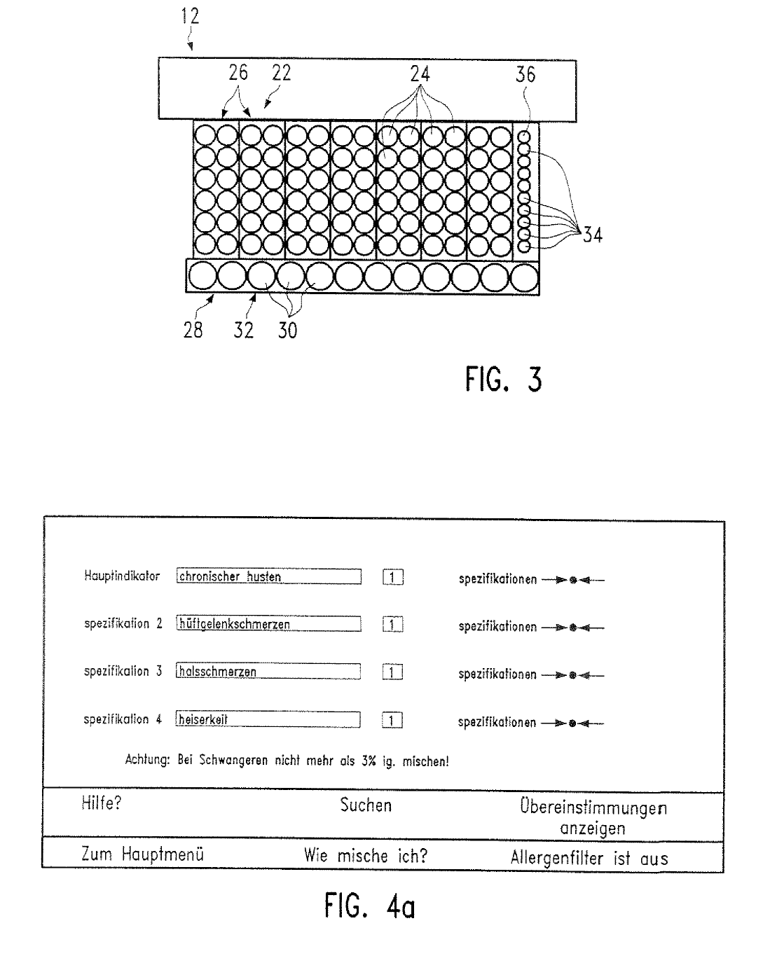

The container arrangement shown in FIG. 3 also comprises a product container arrangement 28 with a number of product containers 30 arranged in a row behind one another. Also, these product containers 30 are provided in a product container holder 32 at a predetermined place, which is mounted on a movable slide which can be moved with respect to the housing 2 in a direction transverse to the longitudinal extension of the row of product containers 30. In the plane of the essential oil container arrangement 22 and of the product container arrangement 28 there are also base oil pots 34 which are connected via a base oil circulation system, not shown in detail, to in each case one of the base oil containers 18. In this base oil circulation system a base oil pump configured as a diaphragm pump is integrated through which the base oil is pumped from the base oil container 18 into the base oil pot 34 and passed back from there to the base oil container 18 like a type of overflow. With this design it is possible, within the level shown in FIG. 3, to arrange the removal points for the base oil and the respective essential oil and the product containers 30 in the smallest space, wherein the travel of the pipetting device 12 and the processing time for the production of a certain oil recipe can be minimised.

The base oil pots 34 are preferably closed off by a septum which can be penetrated by the needle of the pipetting device. Preferably these base oil pots 34 are realised as receptacles in a plastic block. The last receptacle on this plastic block is a pot of cleaning fluid 36 which communicates with a cleaning fluid container 38 arranged at the level of the base oil container via a separate cleaning fluid circulation system As a cleaning fluid particularly a highly volatile liquid, such as alcohol, can be considered. The pots 34 and 36 are accessible from above in the plan view according to FIG. 3. The product containers 30 are small glass bottles which can be placed in the housing 2 without a cap.

The housing comprises a number of housing flaps through which the inside of the housing 2 is accessible. A flap, through which the lowermost level with the central control unit 14 and the label printer 16 as well as the level with the base oil containers 18 and the cleaning fluid container 38 situated above it are accessible, is provided on the rear or side wall.

The level situated above this can be opened via two different flaps. The first housing flap 40 is located on the front wall of the housing 2 beneath the monitor 4 and above the annunciator 6. This first housing flap 40 is dimensioned such that the slide with the product container arrangement 28 can be removed from the housing 2 through the first housing flap 40. Furthermore, a second housing flap is provided which is formed on the rear side wall of the housing according to FIGS. 1 and 2 and through which the slide with the essential oil container arrangement 22 can be removed from the housing 2. In particular for each of the first and second housing flaps a monitoring device is provided which signals the proper closure of the flap. Furthermore, a sensor can be provided which signals the receiving of the slide bearing the essential oil container arrangement and of the slide bearing the product container arrangement in the housing. The signal from the monitoring device and the signal from the sensors monitoring the presence of the slides is a prerequisite for putting the device into operation. In order words, the device is not put into operation if a housing flap is not properly closed and/or one of the slides is not located at the predetermined point.

The arrangement of containers shown in FIG. 3 illustrates an L-shaped alignment on one side of the row of pots 34, 36 and the row of product containers 30 which, in this respect, extends essentially at right angles. Within this L-shaped arrangement and with the same length as the respective limb of the L-shaped arrangement the essential oil container arrangement 22 is located as a rectangular block. The containers or pots 34, 36, 24 are thus arranged in the level illustrated in FIG. 3 on the smallest space. The respective openings of the pots 34, 36 and the essential oil containers 24 as well as the product containers 30 essentially lie in one plane. The essential oil containers 24 are closed off with a septum to prevent the ingress of oxygen and/or contamination into the individual essential oil containers 24. In particular the cap on the individual essential oil containers 24 may be a type of closure such as is known with liquid medication for injection and which can be pierced by a hypodermic needle to remove the liquid from the container. With this preferred embodiment it is possible to provide a protective gas, for example argon, above the liquid level of each base oil container 24 to protect each essential oil from undesired oxidation without the protecting inert gas layer being lost during removal of oil from the containers 24.

The pipetting needle of the pipetting device has a needle tip which is suitable for penetrating this septum. The opening of the pipetting needle is located behind the needle tip and is arranged on the circumference of the needle such that during the penetration of the needle tip into the septum any part of the septum coming away cannot be drawn up by the pipetting device. The pipetting needle communicates with a suction cylinder, the suction volume of which corresponds approximately to ¼ to ⅓ of the volume of the product container. The reason for this figure is that when blending an oil recipe for aromatherapy with a number of essential oils the pipetting device is controlled such that all the essential oils are initially drawn up consecutively by the pipetting device and discharged together into the product container. Consequently, the capacity of a syringe of the pipetting device for accommodating the drawn up liquid must be able to hold the complete volume of the essential oils. Since however the essential oils or essential oil blends are always blended with the base oils, the maximum volume of the pipetting syringe must only correspond to a proportionate volume of the product container.

Regarding the operation of the device: First, the base oil containers 18 and the cleaning fluid container 38 are brought into the second level and connected to the assigned circulation devices. Also, the respective essential oil containers 24 are placed in the holders 26 and pushed into the housing 2 through the second housing flap. Entries are now made in the central control unit to the effect that all containers 18, 38, 24 with their initial charges have been received in the device.

The central control unit 14 furthermore checks for the proper acceptance of the essential oil container arrangement 22 and of the base oil container arrangement 20 in the housing 2.

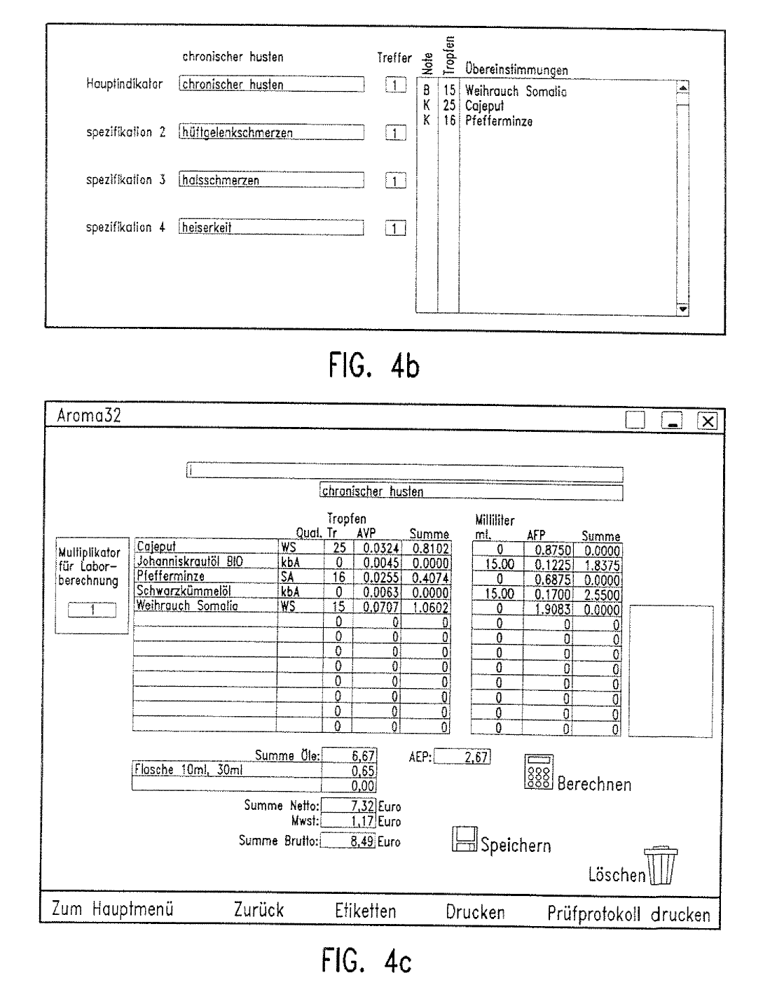

A user approaching the housing 2 now determines via the keyboard 8 and via various monitor masks the desired blending ratio for the single essential oils and for the base oils to be blended with this essential oil blend. In this respect the central control unit 14 generates some masks which are explained in more detail with reference to FIG. 4.

On the monitor first a mask is provided in which the user can enter various indications, i.e. various symptoms. Apart from a main indication, due to which in particular the recommended application of the oil recipe to be blended is specified, two to four symptoms can be specified, which are to be similarly treated with the aromatherapy. Furthermore, criteria specific to the person can be defined, such as for example an existing pregnancy or that the person to whom the therapy is to be applied belongs to a certain group of people (children), which can lead to the elimination of certain essential oils or to the reduction of the concentration of certain essential oils within the overall oil recipe to be determined. These criteria can also be interrogated within the framework of the search for suitable essential oils according to the presentation of the search mask illustrated in FIG. 4a.

Once these parameters have been defined, the central control unit 14 determines the oils suitable for the therapy of the individual symptom based on saved data and determines their blending quantities. If at least one essential oil to therapeutically treat these symptoms has not been found for all four symptoms, then only the essential oil or oils are suggested which have an effect on the symptoms 1 to 3. If no suitable essential oil is found, the oil or oils suitable for therapy of the symptoms 1 and 2 are specified.

With the most common cases the specification of a number of effective essential oils for the therapy of all four symptoms occurs after the search command. In such cases the central control unit 14 determines not only the respective essential oil, but rather also the proportion of the essential oils in the essential oil blend (cf. FIG. 4b). The blend ratio of the single essential oils is determined in particular with regard to the concentration of active ingredients in the individual essential oils. The proportion of a highly concentrated essential oil is in the whole blend then less than the proportion of a less concentrated oil. Based on this blending ratio the price preferably per product container of the thus calculated oil recipe is then calculated (cf. FIG. 4c). This figure also gives the base oils used in the example.

Once the oil recipe has been defined optionally after a prior price check, the device is set in operation. Prior to this, the user put a predetermined number of product containers 30 into the product container holder 32 and pushed it into the housing 2 through the first housing flap 40. After the program has checked the proper positioning of the various container arrangements 22, 28 and the proper closure of the housing flaps, the pipetting device is put into operation. First the pipetting device approaches one of the selected base oils. In this respect the pipetting needle dips into a base oil pot 34, draws up a predetermined quantity of base oil, moves to the product container or containers 30 and discharges the base oil in these containers 30. Then the pipetting device 12 approaches the three containers 24 of the essential oil container arrangement 22 selected in the embodiment. First, the pipetting needle dips into the first essential oil container 24. The pipetting device 12 then moves to the cleaning fluid pot 36 and dips into the cleaning fluid such that essential oil from the first essential oil container clinging to the pipetting needle is washed off. Then the pipetting device 12 moves to the second essential oil container 24, dips into it, draws up the second essential oil and again comes to the cleaning fluid pot 36. Finally, the third essential oil container 24 is approached and also this third component of the oil blend is drawn up into the pipetting needle with predetermined proportion controlled by the control unit 14. Then it can again dip into the cleaning fluid pot 36 or move directly to the product container or containers 30 in order to discharge the complete blend into a container or to discharge a part of the thus manufactured blend consecutively into different product containers 30.

If the pipetting needle has not been previously dipped into the cleaning fluid pot 36, this is now carried out. Then the pipetting needle dips into the base oil pot 34 for the other base oil. The control unit 14 is prepared in such a way that the circulation unit assigned to a base oil pot 34 or to the cleaning fluid pot 36 only comes into operation when the dipping in of the pipetting needle has occurred or is immediately imminent. This ensures that the circulation unit assigned to the pot 34 or 36 only extracts the liquid from the container 18, 38 when there is a requirement for this.

While the oil recipe is automatically prepared by the pipetting device 12 in the product container or containers 30, a label is printed out by the label printer 16 and output through the label output slot 10, which states the calculated blend ratio and which can be stuck on the product container 30. The label printer 16 is furthermore preferably prepared such that it can output a receipt for accounting purposes. Alternatively, the central control unit 14 can also communicate with a cash point where the billing receipt is printed out. It is also conceivable that the device is designed as an autonomous vending machine with the possibility of card reading for a cash card and/or the insertion or drawing in of coins or banknotes and the output of change.

Based on the respective actuation of the pipetting device 12 for drawing up a predetermined liquid volume, the central control unit 14 calculates the amount extracted from a certain container 18, 24 and determines from this extracted amount the amount remaining in the respective containers 18, 24. If the residual volume falls below a lower limit, the control unit produces an acoustic and/or visual signal. Furthermore, on the monitor the position of the respective container 18, 24, i.e. the co-ordinates within the arrangement 20 or 22, is given so that the user can definitely identify the container affected and replace it by a new container. The volume level for the respective container can be reset to the initial volume by the control unit using an acknowledgement signal or by the signal giving the closure of the assigned housing flap.

Alternatively, a level sensor can be provided on the larger base oil containers which measures the level in each container 18.

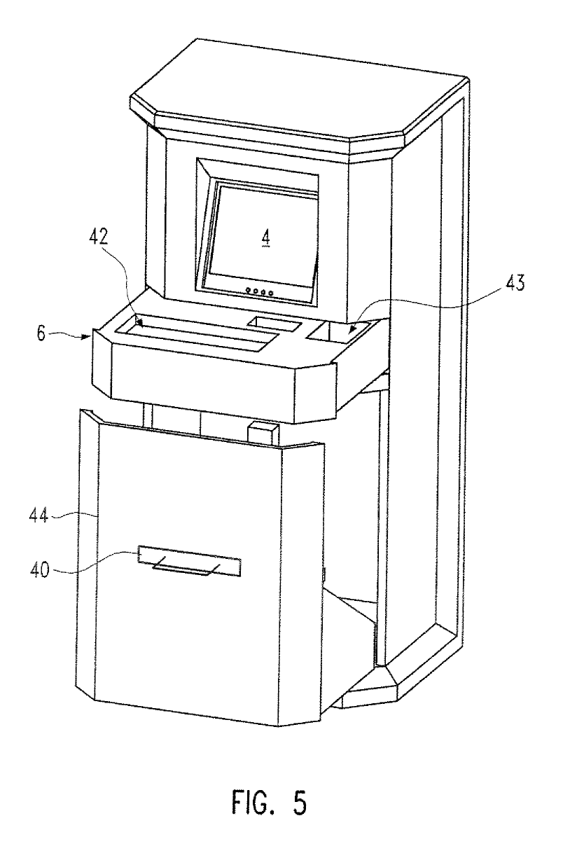

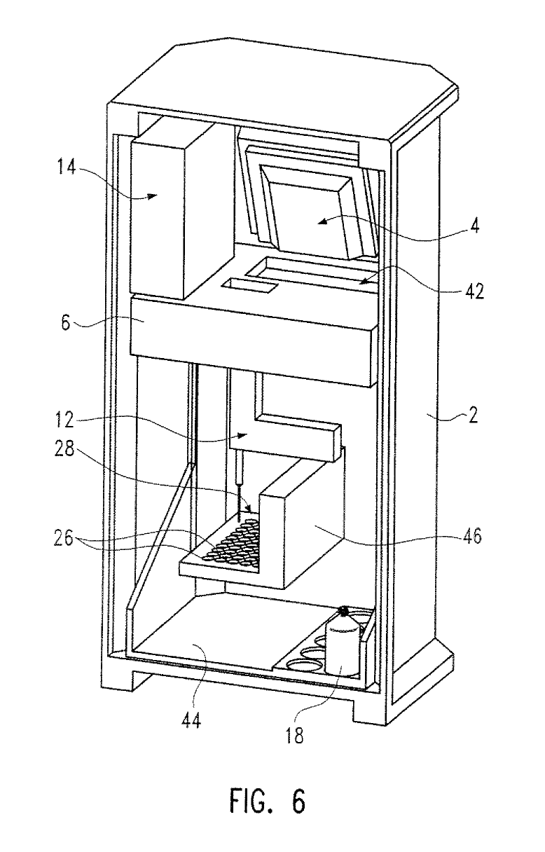

In FIGS. 5 and 6 an alternative embodiment to that illustrated in FIGS. 1 to 3 is shown. The same components are identified with the same reference numerals compared to the previous embodiment.

Compared to the previously discussed embodiment, in the embodiment according to FIGS. 5 and 6 the computer 14 forming the central control unit is at the same height as the monitor 4 and is arranged in the upper part of the housing 2. In the upper part there is also a label printer which is not shown in any further detail, the output slot of which is arranged either at the side next to the monitor 4 or in an annunciator 6, which in the embodiment illustrated in FIGS. 5 and 6 is formed in a movable manner similar to a drawer. Accordingly, the keyboard which is also not shown is located in a keyboard receptacle 42 and the label printer which is not shown is located in a label printer receptacle 43 so that the annunciator 6 has a smooth surface.

The pipetting device 12, the base oil containers 18, the essential oil container arrangement 26 and the product container arrangement 28 are provided on a drawer 44. Here, the base oil container 18 is located on the lowermost level.

The arrangement of the product containers already described with reference to FIG. 3, the essential oil container and the base oil pots are located on the horizontal limb of an L-shaped carrier 46 which is joined to the face side of the drawer 44. The row of product containers is situated immediately adjacent to the inner side of the front wall of the drawer 44 and can be removed by the user through the first housing flap 40 formed on this wall.

Below the L-shaped carrier 46 there are base oil circulation systems, which are not illustrated, for each pump assigned to the individual base oil containers 18 which supply the base oil pots 34. The single base oil circulation systems are surrounded by a trough which holds the base oil in case of a leak. The trough is movable relative to the bottom of the drawer 44 and in fact such that with the drawer 44 pulled out, the trough can be brought sideways next to the drawer 44, in particular on slide rails to the side next to the drawer 44. This arrangement is selected with regard to easy maintenance and repair of the pumps in the circulation systems. The trough is located between the pipetting device 12 and the bottom of the drawer 44.

Preferably, this trough, the rear wall of which is not shown in FIG. 6 for illustrative reasons, also accommodates the base oil containers 18. The rear side of the housing 2 is normally closed off by a rear wall which is not shown in FIG. 6 for illustrative reasons and which is formed as a door so that the parts accommodated in the housing 2 are accessible from the rear of the housing 2 This is required, for example, for installation and assembly purposes. For normal operation access to the lower part of the housing with the drawer 44 pulled out is sufficient. In this configuration the essential oil containers or the base oil containers can be replaced singly. Accordingly, the formation of the housing 2 with a drawer 44 gives a space-saving arrangement of the device taking into account the requirement found in practice with regard to replacing the consumables.

1. A device for the preparation of oil recipes for aromatherapy with an essential oil container arrangement comprising:
a plurality of essential oil containers;
a base oil container arrangement comprising at least one base oil container, the volume of which is larger than the volume of an essential oil container;
a product container arrangement comprising at least one product container;
a pipetting device with a pipetting needle for removing a predetermined volume of a liquid,
a drive unit which moves the pipetting device and by which the pipetting device can be moved in a plane extending parallel to the plane covered by the essential oil container arrangement and the pipetting needle can be brought in a direction perpendicular to this in a selected container; and
a central control unit with assigned data input device for the control of the pipetting device and the drive unit such that a predetermined blend of essential and base oils can be made available in the product device container

2. A device according to claim 1, wherein the openings in the essential oil container are essentially situated in the same plane in which the base oils are held ready for removal by the pipetting device.

3. A device according to claim 1, wherein essentially, in the plane covered by the essential oil container arrangement and for each base oil, a base oil pot is provided to which a base oil circulation system with a base oil pump is assigned, by which base oil can be pumped into the base oil pot from the base oil container and can be passed back from there into the base oil container.

4. A device according to claim 3, wherein the base oil pump is a diaphragm pump.

5. A device according to claim 1, wherein the control unit is formed such that a base oil circulation system is set in operation only in the base oil pot from which the pipetting device is removing base oil.

6. A device according to claim 1, wherein a closed device housing surrounding at least the base oil container arrangement and which comprises a closable first housing flap for the removal of the product container arrangement.

7. A device according to claim 6, wherein a second housing flap provided on the device housing, through which the essential oil container arrangement can be removed from the device housing.

8. A device according to claim 6, wherein a first slide holding the product containers in the product container arrangement, which can be brought into the housing through the first housing flap, and/or a second slide holding the essential oil containers in the essential oil container arrangement and which can be brought into the housing through the second housing opening, and/or a third slide holding the base oil containers in individual receptacles and which can be brought into the housing through a third housing flap and which is arranged on a different plane from the first or second slide.

9. A device according to claim 8, wherein at least one slide and/or at least one monitoring device assigned to a housing flap for monitoring the operational readiness states, the signal of which indicating the operation readiness is a prerequisite for the operation of the device.

10. A device according to claim 6, wherein a drawer, which closes flush with respect to the device housing in the pushed-in state and carries the pipetting device, the product container arrangement, the essential oil container arrangement and the base oil container arrangement.

11. A device according to claim 10, wherein the drawer can be locked in the pushed-in state.

12. A device according to claim 10, wherein the base pumps assigned to the individual base oil containers are arranged on a uniform trough which is provided between the bottom of the drawer and the plane containing the essential oil container arrangement and which can be moved sideways next to the drawer when the drawer is pulled out.

13. A device according to claim 10, wherein the first housing flap is provided on a front surface of the drawer.

14. A device according to claim 1, wherein the base oil pots and the product container arrangement are provided in the plane of the essential oil container arrangement and in each case form the limb of an L-shaped arrangement surrounding the essential oil container arrangement on two sides.

15. A device according to claim 1, wherein the central control unit comprises a memory unit in which the initial volume of the single essential oil containers and/or the single base oil containers are saved and that the central control unit calculates the volume remaining in the respective container based on the amount of essential and base oils removed from the respective essential oil container and/or the base oil container by the pipetting device.

16. A device according to claim 1, wherein the pipetting needle comprises a needle tip with which a septum closing off the essential oil container can be penetrated and that the needle comprises a needle opening, arranged on the needle circumference and adjacent to the needle tip, which communicates with a suction cylinder assigned to the pipetting needle.

17. A device according to claim 1, wherein the suction volume of the suction cylinder corresponds approximately to ⅓ to ¼ of the volume of the product device container.

18. A device according to claim 1, wherein the central control unit comprises a monitor and in the central control unit a program sequence is saved which produces a mask on the monitor for the entry of various symptoms and based on this entry a number of essential oils for therapeutically treating preferably all the symptoms is given, that the program sequence for the specified essential oils determines a blend and that the control unit is prepared such that the pipetting device removes the specified essential oils from the respective essential oil containers and discharges them into at least one of the product containers.

19. A device according to claim 1, wherein the central control unit (14) determines the volume of the essential oil blend and at least one suitable base oil for it as well as the volume of the base oil for discharge into the product container, and that the central control unit controls the pipetting device such that initially a volume proportion of the base oil, then the essential oil blend and then the remaining volume proportion of the base oil are discharged into the product device container.

20. A device according to claim 1, wherein the central control unit (14) controls the pipetting device such that the essential oils are removed consecutively from the essential oil containers by the pipetting device and are output together into the product device container.

21. A device according to claim 1, wherein a cleaning vessel, which is provided in the plane of the essential oil arrangement and to which a cleaning fluid circulation system with an assigned cleaning fluid reservoir is assigned and that the central control unit is prepared such that the pipetting needle is dipped into the cleaning vessel before moving to the next essential oil container.

22. A device according to claim 1, wherein the control unit is formed such that a cleaning fluid circulation system is only put into operation when the pipetting device is cleaned

23. A device according to claim 1, wherein a label printer, which is accommodated in the housing and is controlled by the central control unit and which prints out a label stating the blend ratio of the essential oil blend and outputs it through a label output slot in the housing.
